(19) United States
(12) Patent Application Publication
(10) Pub. No.: US 2007/0053809 A1
(43) Pub. Date: Mar. 8, 2007

(54) Mixing device

(75) Inventors: Martin Brenner, Kieselbronn (DE); Herbert Damsohn, Aichwald (DE); Conrad Pfender, Besigheim (DE)

Correspondence Address: FOLEY AND LARDNER LLP;SUITE 500, 3000 K STREET NW, WASHINGTON, DC, 20007, US

(73) Assignee: Behr Gmbh & Co.KG

(21) Appl. No.: 10/553,404

(22) PCT Filed: Apr. 6, 2004
(86) PCT No.: PCT/EP04/03667

§ 371 Date: Jun. 29, 2006

(30) Foreign Application Priority Data
Apr. 17, 2003 (DE) 10318061.3

(51) Int. Cl. B01J 19/18

(52) U.S. Cl. 422/225

(57) ABSTRACT

The invention relates to a mixing device for mixing at least two media comprising at least one mixing chamber (177). The inventive device is characterised in that the wall (104, 110) of the mixing chamber is provided with at least one temperature control channel.

The invention relates to a device for mixing at least two media, having at least one mixing chamber.

Devices of this type are usually used to mix a plurality of media, which are then to undergo one or more chemical reactions with one another. For this purpose, the mixture is fed to a reaction chamber, in which the conditions, such as for example the temperature, are matched to the requirements of the desired reaction. On account of the geometric shape, the dimensions or also the function of devices of this type, the mixing of the media is generally incomplete and the temperature distribution inhomogeneous, and consequently in addition to an intended main reaction, undesirable secondary reactions often also occur. Furthermore, in the case of fast chemical reactions, the mixing rate is often slower than the reaction rate, with the result that the yield of the chemical reaction is substantially determined by the mixing device.

DE 44 33 439 A1 describes a mixing device in which a mixing operation is supposed to be accelerated by two starting-material streams being in each case divided by microchannels into spatially separate fluid threads, which then emerge into a mixing space as free jets. In this way, mixing of the starting-material streams is promoted by diffusion and/or turbulence.

In the case of chemical reactions, however, in addition to intimate mixing, a favorable temperature distribution is a crucial factor in determining the yield of reaction products. In particular reactions which take place quickly and under certain circumstances may even commence in a mixing chamber, not only require homogeneous mixing, but also are generally endothermic or exothermic, so that controlled temperature management even for mixing chambers is desirable.

The invention is based on the object of providing a device which allows at least two media to be mixed while thermal energy is at the same time being supplied or removed.

This object is achieved by a device for mixing at least two media, such as a mixing device, having the features of claim 1.

The basic concept of the invention is to simultaneously mix and control the temperature of at least two media, in particular starting materials for a subsequent chemical reaction.

A mixing device according to the invention has at least one mixing chamber, to which at least two media can be fed in order to be mixed with one another, for example by turbulence and/or diffusion. It is also conceivable for three or more media to be mixed with one another, in which case the media can either be fed to a mixing chamber simultaneously or can be successively admixed with a medium or mixture in one or more mixing chambers. There is at least one temperature control channel, through which energy can be fed to or removed from the at least one mixing chamber, in a wall of the at least one mixing chamber.

With a mixing device of this type, it is possible to produce a desired temperature distribution, in particular a uniform temperature distribution, in the mixture as early as during mixing of at least two media. As a result, the mixing and temperature control operations overall are accelerated, and it may be that a yield of a subsequent reaction is increased.

Preferably, energy in the form of thermal energy can be transferred from a medium or mixture in the at least one mixing chamber, through the wall of the latter, to the at least one temperature control channel, or vice versa.

According to an advantageous embodiment of the invention, energy in the form of electrical energy can be transported through the at least one temperature control channel. This is preferably done with the aid of power lines which are arranged in the at least one temperature control channel. A thermoelectric element, such as for example a resistance heater, in particular with a positive temperature coefficient, or a peltier cooling element, can be used to convert thermal energy into electrical energy or vice versa.

According to a further advantageous embodiment, energy can be transported convectively by means of a temperature control medium through the at least one temperature control channel. For this purpose, the temperature control channel is designed, for example, as part of a temperature control circuit, in which case the temperature control circuit is, for example a cooling circuit or a refrigerant circuit. In these exemplary embodiments, the temperature control medium is a coolant, such as for example water or a water-glycol mixture, or a refrigerant, such as for example R134a or CO₂. It is equally possible for the temperature control channel also to be open, so that, for example, ambient air can flow through it, which air can be delivered through the temperature control channel in particular with the aid of an air delivery device, such as for example a blower, a fan or an air pump.

It is preferable for the mixing device to have a reaction chamber for a chemical reaction between the at least two media and/or a mixture thereof, so that the mixture can be fed to the reaction chamber within the shortest possible distance. As a result, the overall “mixing/temperature control/reaction” process is further shortened and the corresponding yield increased. It is particularly preferable for the reaction chamber to be designed in channel form, so that the at least two media or the mixture thereof can flow through it.

It is also particularly advantageous to use a catalyst for a desired chemical reaction in the at least one reaction chamber. This assists with a desired reaction and under certain circumstances may prevent undesirable secondary reactions in favor of the desired reaction. For this purpose, a catalyst material is preferably applied to a wall of the at least one reaction chamber. It is also advantageous if a wall of the at least one reaction chamber at least partially comprises a catalyst material.

It is particularly preferable for the at least one mixing chamber to be integrated in the at least one reaction chamber. As a result, it is possible for the reaction to start as early as during the mixing and temperature control, and for the abovementioned overall “mixing/temperature control/reaction” process to be shortened further, with a further increase in the corresponding yield.

According to a preferred configuration of the device for mixing two media, the at least one mixing chamber can have a main direction of flow through it. For this purpose, the at least one mixing chamber is advantageously designed in channel form, so that it is easy to control the temperature of the at least two media or the mixture of these media as it/they flow(s) through the mixing chamber. Moreover, it is in this way even possible to impart a temperature profile which may be desired under certain circumstances to the mixing chamber.

According to an advantageous embodiment, the mixing device operates according the parallel-current principle or according to the countercurrent principle. For this purpose, the at least one temperature control channel runs substantially parallel to the main direction of flow of the at least one mixing chamber. The parallel-current principle or the countercurrent principle is realized depending on the direction of flow through the temperature control channel with respect to the main direction of flow of the mixing chamber.

According to a further advantageous embodiment, the mixing device operates according to the cross-current principle. For this purpose, the at least one temperature control channel runs transversely with respect to the main direction of flow of the at least one mixing chamber. When seen in a suitable projection, the flow paths then cross one another, so as to realize the cross-current principle.

In a preferred configuration of the invention, the at least one mixing chamber has one or more turbulators. This prevents laminar flow of the at least two media, which would otherwise be possible under certain circumstances, and allows more homogeneous mixing. It is particularly preferable for at least one turbulator to be designed as a transverse web, with the result that if appropriate a very simple design of the mixing device can be realized.

According to an advantageous configuration, the mixing device has an inlet for each of the at least two media and an outlet for in each case at least one mixing or reaction product, so that it is easy for the device to be connected to corresponding lines. If appropriate, the mixing device may also be provided with an inlet and an outlet for the temperature control medium.

According to a preferred embodiment of the device according to the invention, the wall of the at least one mixing chamber comprises a plurality of plates and/or sheets bearing against one another, with the at least one temperature control channel and the at least one mixing chamber being formed by cutouts in the plates or sheets. It is particularly preferable for the mixing device to comprise a plurality of plates and/or sheets bearing against one another, in which case under certain circumstances the at least one reaction chamber may also be formed by one or more cutouts in the plates or sheets. This allows a modular structure of a mixing device according to the present invention with the aid of plates/sheets which may under certain circumstances be standardized, resulting in a simplified and possibly very compact design.

According to a preferred refinement, the two outermost plates/sheets can be connected to one another by means of a holding device. This on the one hand makes it possible to fix and clamp a plate stack during production of the mixing device and on the other hand also stabilizes the mixing device during operation, for example with respect to the action of pressurized media, so that the strength and consequently also the service life of the mixing device are enhanced.

The dimensions of the plates or sheets are expediently selected in such a way that the channels and chambers formed by cutouts have a cross-sectional area which is sufficient for the intended application and that a sufficient stability of the mixing device during operation is ensured; a compact design in terms of size and weight should preferably also be taken into account.

It is preferable for the plates and sheets to be between 0.05 mm and 1.5 mm, particularly preferably between 0.2 mm and 2.5 mm, thick. The cutouts in the plates or sheets are preferably between 1 mm and 10 mm wide, particularly preferably between 2 mm and 10 mm wide.

To achieve a stable design of the mixing device, at least one component of the device is preferably made from a metal, particularly preferably from aluminum, titanium or tantalum, from a stainless steel, from an alloy, particularly advantageously a nickel alloy, or from a plastic.

According to the present invention, a brazed mixing device is advantageous, in which case a brazing solder preferably contains or particularly preferably consists of nickel, gold, silver and/or copper. A welded, in particular diffusion-welded, or adhesively bonded mixing device is also advantageous.

The invention is explained in more detail below on the basis of exemplary embodiments and with reference to the drawings, in which:

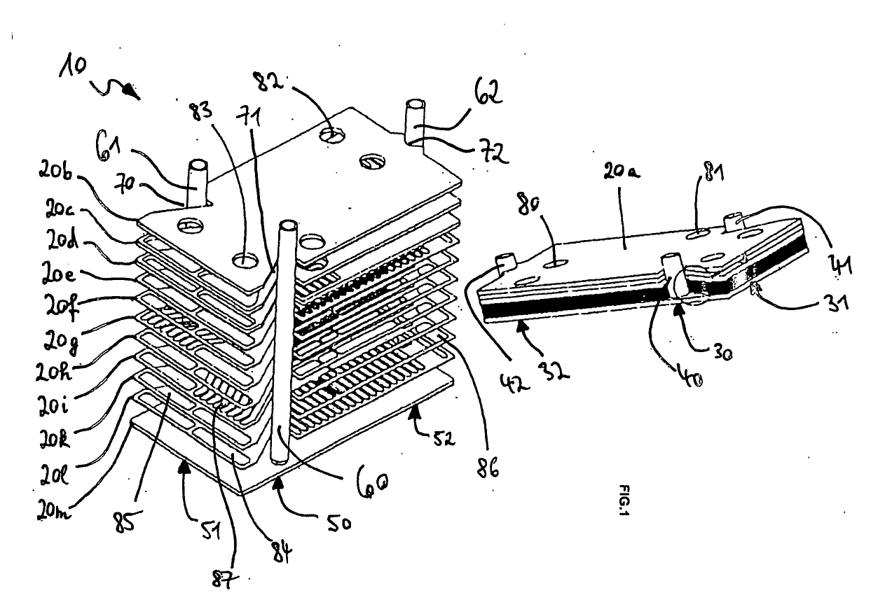

FIG. 1 shows a structure of a mixing device according to the present invention,

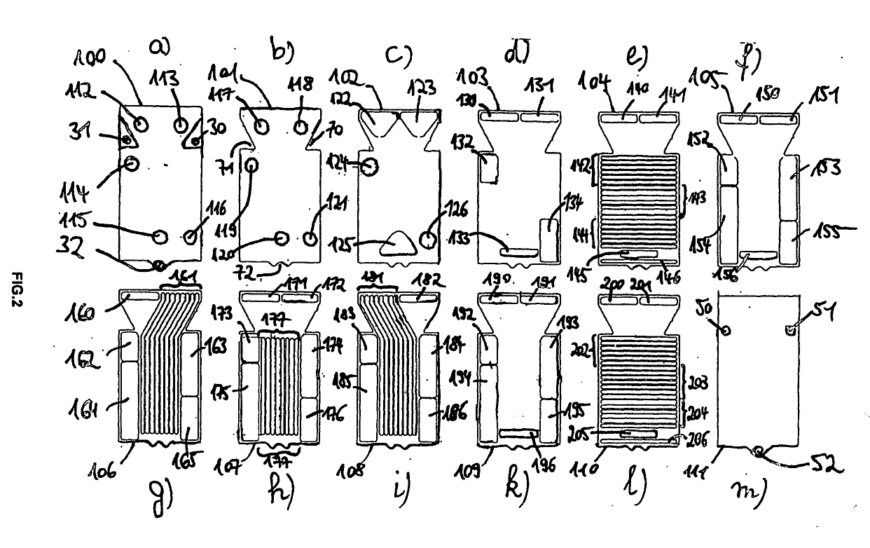

FIGS. 2a-2m show a plan view of in each case one plate of a mixing device,

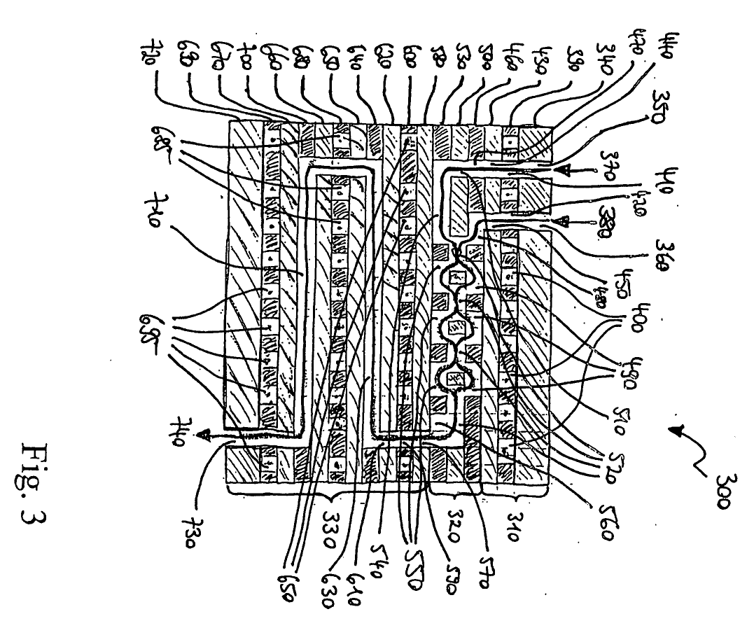

FIG. 3 shows a cross-sectional view of a mixing device,

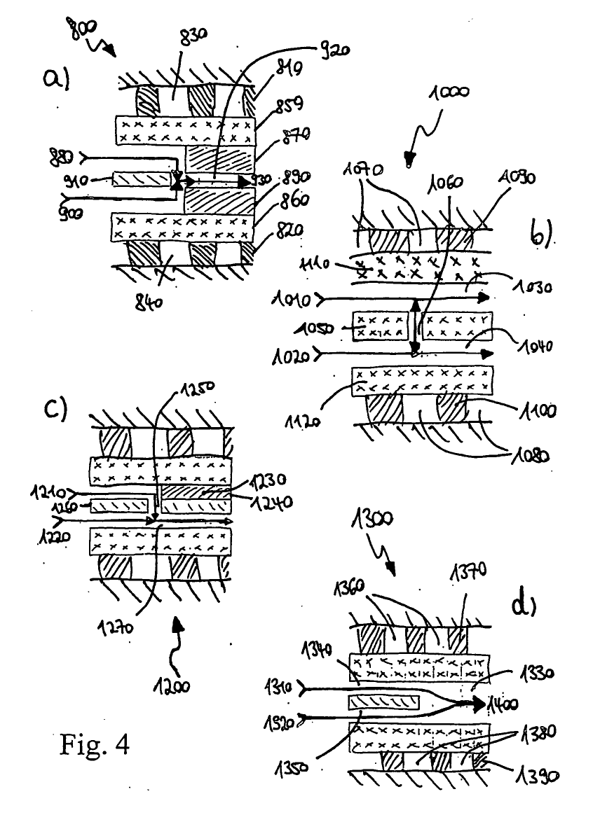

FIGS. 4a-4d in each case show a cross-sectional view of a mixing chamber of a mixing device, and

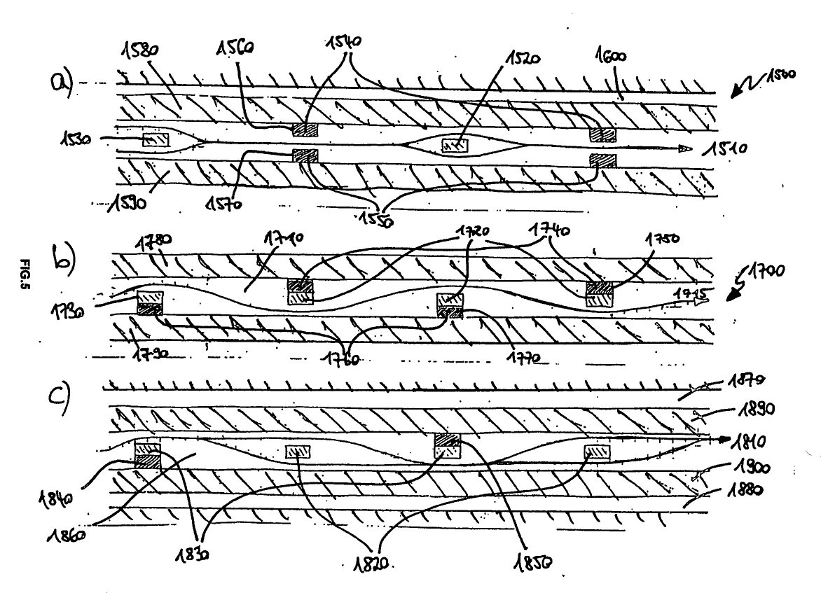

FIGS. 5a-5c each show a cross-sectional view of a mixing chamber of a mixing device.

FIG. 1 shows, as an exemplary embodiment of a device according to the invention for mixing two media, a mixing device 10 with integrated reactor, in the form of an exploded view. The mixing device 10 comprises a plurality of plates 20a to 20m which are stacked on top of one another and are made, for example, from titanium, tantalum, a stainless steel or a nickel alloy. The plates are structured for example by means of etching, laser cutting or also, in the case of materials which cannot be etched or are difficult to etch, by means of precision-blanking or water jet cutting.

To produce the mixing device, the plates 20a to 20m are placed on top of one another and joined to one another in a fluid-tight manner, for example by welding, in particular diffusion welding, or brazing, in particular high-temperature brazing, in which case suitable brazing solders are in particular nickel, gold, silver or copper brazing solders. When selecting the plate materials and brazing solders, it should be ensured that they do not catalyze any undesirable reactions while the mixing device is operating.

It can be seen from FIG. 1 that the cover plate 20a is composed of a plurality of individual layers and has three securing apertures 30, 31, 32 (cf. also FIG. 2a), through which securing elements 40, 41, 42 designed as tube pieces can be fitted. The baseplate 20m has securing apertures 50, 51, 52 (cf. also FIG. 2m) positioned opposite the apertures 31, 30, 32 in the cover plate 20a. Securing elements 60, 61, 62 can be fitted through the apertures 50, 51, 52, with the result that the tube pieces 40, 41, 42 can be connected to the elements 60, 61, 62, which are likewise designed as tube pieces, in such a manner that the mixing device can satisfy high strength demands, for example with regard to internal pressure loads. The plates 20b to 201 have notches 70, 71, 72 (cf. also FIG. 2b), which serve to receive the tube pieces 40, 41, 42 and 60, 61, 62 in a space-saving way.

It is advantageous for the tube pieces 40, 41, 42 to be formed in integral pairs with the tube pieces 60, 61, 62, namely tube piece 40 with 61, tube piece 41 with 60 and tube piece 42 with 62, so as to reduce the number of assembly steps.

Furthermore, the plates 20a to 201 have cutouts 80, 81, 82, 83, 84, 85, 86, 87 for routing starting-material, product and temperature control medium streams of a chemical reaction, the connection between which will be explained with reference to FIG. 2.

FIG. 2 shows a set of plates 100, 101, 102, 103, 104, 105, 106, 107, 108, 109, 110, 111, which correspond to the plates 20a to 20m shown in FIG. 1, in the form of plan views. A mixing device results from the plates being stacked on top of one another in this order. Specifically, these plates are a cover plate 100 (FIG. 2a), a connection plate 101 (FIG. 2b), a redistribution plate 102 (FIG. 2c), a separating plate 103 (FIG. 2d), a first temperature control plate 104 (FIG. 2e), a first heat conduction plate 105 (FIG. 2f), a first distribution plate 106 (FIG. 2g), a mixing plate 107 (FIG. 2h), a second distribution plate 108 (FIG. 2i), a second heat conduction plate 109 (FIG. 2k), a second temperature control plate 110 (FIG. 21) and a baseplate 111 (FIG. 2m). Since plates 104 and 110, and also plates 105 and 109, are structurally identical, the mixing device can be assembled from ten different types of plates.

The mixing device functions as follows. A first medium, which is to be mixed with a second medium, flows from the connection 112 in plate 100 through the cutout 117 in plate 101, is then redistributed by means of the cutout 122 in plate 102 into a first distribution chamber, which is formed by the cutout 130 in plate 103, the cutout 140 in plate 104, the cutout 150 in plate 105, the cutout 160 in plate 106, the cutout 171 in plate 107, the cutout 190 in plate 109 and the cutout 200 in plate 110. The first distribution chamber distributes the stream of the first medium between first distribution channels 181 in plate 108, which are closed off by the plates 107, 109.

Similarly, the second medium is passed through the cutouts 113, 118, 123 into a second distribution chamber, which is formed by the cutouts 131, 141, 151, 172, 182, 191 and 201. From there, the second medium is distributed between second distribution channels 161 in plate 106, which are closed off by the plates 105, 107.

The first distribution channels 181 and the second distribution channels 161 are separated from one another only by the mixing plate 107, the cutouts 177 in which connect the first distributions channels 181 to the second distribution channels 161 so as to form mixing chambers. The first medium and the second medium are mixed with one another in these mixing chambers, after which the mixing medium is collected in a collection chamber, which is formed by the cutout 133 in plate 103, the cutout 145 in plate 104, the cutout 156 in plate 105, the cutout 196 in plate 109 and the cutout 205 in plate 110. From this collection chamber, finally, the mixing medium flows through the cutout 125 in plate 102 and the cutout 120 in plate 101 to the connection 115 in the cover plate 100.

In a similar way, a temperature control medium, such as for example coolant, is passed from the connection 114 via the cutouts 119, 124 into a temperature control medium distribution chamber, which is formed by the cutouts 132, 152, 162, 173, 183, 192 in the plates 103, 105, 106, 107, 108, 109. From there, the temperature control medium is passed through first temperature control channels 142, 202 in the temperature control plates 104, 110 to a first diverting chamber, which is formed by the cutouts 153, 163, 174, 184, 193 in the plates 105, 106, 107, 108, 109. From there, the temperature control medium flows via second temperature control channels 143, 203 in the plates 104, 110 to a second diverting chamber, which is produced by the cutouts 154, 164, 175, 185, 194 in the plates 105, 106, 107, 108, 109, and then through third temperature control channels 144, 204 in the plates 104, 110 into a temperature control medium collection chamber, which is formed by the cutouts 134, 155, 165, 176, 186, 195 in the plates 103, 105, 106, 107, 108, 109. The first, second and third temperature control channels are closed by the plates 103, 105 and by the plates 109, 111.

The temperature control medium is collected in the temperature control medium collection chamber and finally passed via the cutouts 126, 121 in the plates 102, 101 to the connection 116 in the cover plate 100. Therefore, the cover plate 100 has a total of five connections, namely an inlet 112 for the first medium, an inlet 113 for the second medium, an outlet 115 for the mixing medium and an inlet 114 and an outlet 116 for the temperature control medium.

The plates 100 and 102 may also be placed directly against one another, thereby eliminating one plate, namely the connection plate 101. The function of the connection plate is then undertaken by the cover plate 100. Given a suitable arrangement of the inlet and outlet openings in the cover plate 100, the plates 100 and 103 could also be placed directly against one another, so that then only eight different types of plate are required to construct a mixing device.

In the exemplary embodiment described here and shown in FIG. 2, the flow through the channel-like mixing chambers, which are formed by the cutouts 161, 177 and 181 in the plates 106, 107 and 108, respectively, is from the top downward, and these mixing chambers are surrounded by walls which are formed inter alia on the one hand by the stacked plates 100, 101, 102, 103, 104, 105 and on the other hand by the stacked plates 109, 110, 111.

The temperature control channels 142, 143, 144 and the temperature control channels 202, 203, 204, which are in each case separated from the mixing chambers only by one plate, namely the plate 105 or the plate 109, are situated in these walls. On account of heat conduction through the plates 105, 109, energy in the form of heat is transported from the mixing chambers to the temperature control medium in the temperature control channels, or vice versa. In this way, the energy is removed from the mixing chambers or fed to the mixing chambers by convection with the aid of the flowing temperature control medium.

The temperature control channels 142, 143, 144, 202, 203, 204 run transversely with respect to the direction of flow through the mixing chambers, and consequently in the exemplary embodiment described it is in principle also possible to talk of a cross-current heat exchanger. On account of the meandering flow through the temperature control channels, it is possible in particular to speak of a cross-cocurrent or cross-countercurrent heat exchanger, depending on the direction in which the temperature control medium is passed through the mixing device.

A further exemplary embodiment results from a modification to the configuration described, by virtue of the mixing chambers simultaneously serving as reaction chambers, i.e. the first medium reacts with the second medium. This is preferably effected by a catalyst for the desired reaction, which is introduced, for example, into the mixing chambers. The mixing chambers are then integrated in the reaction chambers, so that very effective mixing and reaction of the first medium and the second medium with one another is possible.

On account of the geometry of the channels, in particular a flow of temperature control medium which has a high heat transfer coefficient is established, so that heat can be supplied or dissipated with a high energy flux density. As a result, the reaction can take place at a more uniform temperature, advantageously under virtually isothermal conditions, resulting in improved efficiency, i.e. an increased yield of the reaction.

In particular, the channels in the individual layers are distinguished by very small hydraulic diameters. Depending on the desired reaction, a height of between 0.05 mm and 1.5 mm and a width of between 1 mm and 10 mm may in each case be preferable for the distribution channels, and a height of between 0.2 mm and 1.5 mm and a width of between 2 mm and 10 mm may in each case be preferable for the temperature control channels.

Should the cross sections of flow be insufficient for desired mass flows, it is also possible for a plurality of mixing devices to be connected in parallel; these mixing devices may also be formed in a single structural unit. It is also conceivable to use lengthened reaction channels which, for example, extend over a plurality of plates, so that the mixing media can be passed through the mixing device at a greater flow velocity while at the same time achieving a sufficient residence time in the reaction chambers.

In another exemplary configuration, the mixing channels 177 in plate 107 are in each case interrupted by one or more transverse webs, so that the first medium and the second medium or the mixture thereof, during flow through the mixing chambers, is/are diverted into the distribution channels 161 and/or 181 in the plates 106 and/or 108, respectively. As a result under certain circumstances turbulence is generated or stimulated in the mixture, so that mixing is improved.

FIG. 3 shows a further exemplary embodiment of a mixing device 300 according to the present invention in the form of a cross-sectional view. The mixing device 300 is composed of a plurality of stacked plates and is in principle divided into three regions, namely an inflow region 310, a mixing region 320 and a reactor region 330; when the mixing device 300 is operating, it is not necessarily imperative to maintain this separation. By way of example, a reaction may also start in the mixing region 320.

The inflow region comprises a cover plate 340 with two cutouts 350, 360 as inlets for a first starting material 370 and a second starting material 380, respectively. Beneath the cover plate 340 is a first temperature control plate 390 with a plurality of cutouts which serve to form temperature control channels 400, it being possible for a temperature control medium to flow through the temperature control channels 400 into the plane of the drawing and/or out of the plane of the drawing. Furthermore, the first temperature control plate 390 has two cutouts 410, 420 for the first starting material 370 and the second starting material 380 to pass through. A first heat-conducting plate 430, likewise with two cutouts 440, 450 for the first starting material 370 and the second starting material 380 to pass through, is connected to the first temperature control plate 390.

The mixing region 320 is likewise composed of three plates. A first distribution plate 460 has a cutout 470 for the first starting material 370 to pass through, a cutout 480 forming a distribution channel for the second starting material 380, and cutouts 490 for forming mixing channels. A cutout 510 for the first starting material 370 to pass through and cutouts 520 for forming the mixing channels are provided in a mixing plate 500. A second distribution plate 530 has a cutout 540 for forming a distribution channel for the first starting material 370, cutouts 550 for forming mixing chambers and a cutout 560 for the starting-material streams 370, 380 which have been mixed with one another to pass through.

The mixing plate 500 is arranged between the distribution plates 460, 530 in such a manner that the cutouts 490, 520 and 550 come to lie offset above one another. The mixing chambers which are formed in this way and in which the two starting-material streams 370, 380 come together, consequently have transverse webs, so as to increase turbulence in the flow and therefore improve mixing of the starting materials 370, 380.

The mixture formed then passes into the reactor region 330, where it passes via a cutout 570 in a second heat conduction plate 580, a cutout 590 in a second temperature control plate 600 and a cutout 610 in a third heat conduction plate 620 into a first reactor chamber 630. The reactor chamber is in this case formed by a cutout 630 in a first reactor plate 640. Cutouts 650 in the second temperature control plate 600 serve to provide a temperature control medium, so that heat can be taken from the mixing chambers and/or the reactor chamber via the heat conduction plates to a cooling medium or from a heating medium in the temperature control channels to the starting-material mixture. A high level of heat transfer is made possible by producing a low overall height of the heat conduction plates (for example 1.5 mm or less, in particular 1 mm) and/or selecting a suitable material with a high thermal conductivity for the heat conduction plates. In the exemplary embodiment illustrated in FIG. 3, the direction of flow through the temperature control channels 400, 650 is out of the plane of the drawing or into the plane of the drawing, so that a cross-current, cross-cocurrent or cross-countercurrent heat transfer can be implemented.

On account of the modular structure of the mixing device 300, comprising a multiplicity of plates, it is easy to extend the reactor region 330 by arranging a plurality of assemblies comprising similar or identical plates in series. The reactor plate 640 is adjoined by further heat conduction plates 650, 660, 670, temperature control plates 680, 690 with temperature control channel cutouts 685, 695 and a reactor plate 700 with a second reactor chamber 710. It will be understood that in other embodiments, it is also possible for further assemblies with heat conduction plates and/or temperature control plates and/or reactor plates to be connected without departing from the scope of the present invention. Moreover, the reactor chambers are optionally provided with at least one catalyst, for example by the heat conduction plates which adjoin them being coated with catalyst material or consisting of catalyst material.

A baseplate 720 with a cutout 730 for forming an outlet for the reaction product 740 forms the lower termination of the mixing device 300.

If structurally identical plates are used, it is possible to reduce the number of different types of plates. By way of example, the plates 340 and 430, the plates 390, 600, 680 and 690, the plates 580, 620, 650, 660, 670 and 720 or the plates 640 and 700 may in each case be structurally identical to one another, so that only seven different types of plate shape are required to construct the mixing device 300.

FIG. 4 shows various possible ways of combining two starting-material streams. Between two temperature control plates 810, 820 with temperature control channels 830, 840, the mixing device 800 (FIG. 4a) has two heat conduction plates 850, 860, a first distribution plate 870 for a first medium 880, a second distribution plate 890 for a second medium 900 and a mixing plate 910 with a mixing chamber 920. The two starting-material streams are diverted symmetrically with respect to one another, come into contact with one another and are mixed with one another, in particular through turbulence and/or diffusion. In particular on account of the two starting-material streams meeting one another “front-on”, intensive mixing is achieved, with the result that a substantially homogeneous mixture 930 can be realized.

In the mixing device 1000 (FIG. 4b), two starting-material streams 1010, 1020 flow parallel to one another through distribution channels 1030, 1040 in distribution plates, between which is arranged a mixing plate 1050 with cutouts 1060. The cutouts 1060 form mixing channels, via which the distribution channels 1030, 1040 are in communication with one another, so that the two starting materials 1010, 1020 are exchanged and therefore mixed with one another. By way of example, an externally controllable or at least desirable pressure difference between the starting-material streams 1010 and 1020 could form the basis of or promote such exchange. The temperature control channels 1070, 1080 in the temperature control plates 1090, 1100 serve to control the temperature of the distribution channels 1030, 1040 via the heat conduction plates 1110, 1120.

The mixing device 1200 (FIG. 4c) differs from the mixing device 800 mainly by virtue of the fact that the starting-material streams 1210, 1220 meet one another asymmetrically rather than symmetrically. This is achieved by virtue of the fact that the starting-material stream 1210 is diverted at a transverse web 1230 in a distribution plate 1240 and meets the distribution channel 1270 in a further distribution plate via a cutout 1250 in the mixing plate 1260. This asymmetric variant is recommended in particular for mixing ratios which differ from one, for example if a small starting-material stream 1210 is to be admixed with a relatively large starting-material stream 1220.

In the mixing device 1300 (FIG. 4d), two starting materials 1310, 1320 flow symmetrically into a mixing chamber 1330, the cross section of which is larger than the sum of the cross sections of the distribution channels 1340, 1350. This slows down the flow as it enters the mixing chamber, in which case, on account of the associated longer residence time in the mixing chamber 1330, under certain circumstances better mixing of the two starting materials 1310, 1320 is possible. On account of the temperature control channels 1360 in the temperature control plate 1370 being arranged offset with respect to the temperature control channels 1380 in the temperature control channels 1390, it is possible to achieve a more uniform temperature distribution along the main direction of flow of the starting materials 1310, 1320 or the mixture 1400.

FIG. 5 shows three examples of mixing chambers which have turbulence-generating or turbulence-increasing transverse webs in order to improve the mixing. In the case of the mixing device 1500 (FIG. 5a), a flow of a mixture 1510 is multiply divided and in each case combined again, at the same time being additionally bundled together. For this purpose, transverse webs 1520 of a mixing plate 1530 are arranged offset with respect to transverse webs 1540, 1550 of a first distribution plate 1560 and a second distribution plate 1570, respectively. Heat conduction plates 1580, 1590 and a temperature control channel 1600, which in the present exemplary embodiment runs parallel to a main direction of flow of the mixture in the mixing chamber, i.e. from left to right in FIG. 5a, can also be seen in this figure.

The mixing chamber 1710 of the mixing device 1700 (FIG. 5b) has transverse webs which alternately force a flow 1715 to two opposite sides of the mixing chamber 1710. For this purpose, transverse webs 1720 of a mixing plate 1730 are alternately joined to transverse webs 1740 of a first distribution plate 1750 and transverse webs 1760 of a second distribution plate 1770. The mixing chamber 1710 is closed off by two heat conduction plates 1780, 1790, which in turn adjoin temperature control plates (not shown here) with temperature control channels.

In the case of the mixing device 1800 (FIG. 5c), a flow of a mixture 1810 is alternately divided by free-standing transverse webs 1820 and forced to an edge of a mixing chamber 1860 by webs 1830, 1840, 1850 which are joined to one another. This may further boost turbulence in a flow in the mixing chamber 1860. The temperature of the mixture 1810 is controlled with the aid of a temperature control medium, which flows through temperature control channels 1870, 1880 and releases heat to the mixture 1810 or takes up heat from the mixture 1810 via heat conduction plates 1890, 1900.

The present invention has been described on the basis of the example of a mixing device for two media intended for a reaction. However, it should be noted that the mixing device according to the invention is also suitable for other purposes.

1. A device for mixing at least two media, having at least one mixing chamber, wherein a wall of the at least one mixing chamber has at least one temperature control channel for feeding or removing energy to or from the at least one mixing chamber.

2. The device as claimed in claim 1, wherein energy can be fed to or removed from the at least one mixing chamber electrically through the at least one temperature control channel.

3. The device as claimed in claim 1, wherein energy can be fed to or removed from the at least one mixing chamber convectively by means of a temperature control medium through the at least one temperature control channel.

4. The device as claimed in claim 1, wherein the device has at least one reaction chamber, in particular in channel form, for a chemical reaction between the at least two media.

5. The device as claimed in claim 1, wherein a wall of the at least one reaction chamber is provided with at least one catalyst material or consists of a catalyst material.

6. The device as claimed in claim 1, wherein at least one mixing chamber is integrated in the at least one reaction chamber.

7. The device as claimed in claim 1, wherein at least one mixing chamber has a main direction of flow through it and in particular is designed in channel form.

8. The device as claimed in claim 1, wherein at least one temperature control channel runs substantially parallel to the main direction of flow of the at least one mixing chamber.

9. The device as claimed in claim 1, wherein at least one temperature control channel runs substantially transversely with respect to the main direction of flow of the at least one mixing chamber.

10. The device as claimed in claim 1, wherein at least one mixing chamber is provided with at least one turbulator, which is designed in particular as a transverse web.

11. The device as claimed in claim 1, wherein an inlet for each of the at least two media and if appropriate also for the temperature control medium, and an outlet for in each case at least one mixing and/or reaction product and if appropriate for the temperature control medium.

12. The device as claimed in claim 1, wherein the wall of the at least one mixing chamber comprises a plurality of plates and/or sheets bearing against one another, and in that in particular the device for mixing at least two media comprises a plurality of plates and/or sheets bearing against one another, with the at least one temperature control channel, the at least one mixing chamber and if appropriate the at least one reaction chamber being formed by cutouts in the plates or sheets.

13. The device as claimed in claim 1, wherein the two outermost plates can be connected to one another by means of a holding device.

14. The device as claimed in claim 1, wherein at least one of the plates or sheets is between 0.05 mm and 1.5 mm, in particular between 0.2 mm and 1.5 mm, thick.

15. The device as claimed in claim 1, wherein the cutouts in the plates or sheets are between 1 mm and 10 mm wide, in particular between 2 mm and 10 mm wide.

16. The device as claimed in claim 1, wherein at least one component of the device consists of a metal, in particular titanium or tantalum, of a stainless steel, of an alloy, in particular a nickel alloy, or of a plastic.

17. The device as claimed in claim 1, wherein the device is brazed, in which case a brazing solder in particular contains or consists of nickel, gold, silver and/or copper.

18. The device as claimed in claim 1, wherein the device is welded, in particular diffusion-welded, or adhesively bonded.
